(19) United States
(12) Patent Application Publication
(10) Pub. No.: US 2026/0281213 A1
(43) Pub. Date: Sep. 17, 2026

(54) SCHEDULING A DELAY SENSITIVE DATA TRANSMISSION

(71) Applicant: Google LLC, Mountain View, CA (US)

(72) Inventors: Shiangrung YE, Taipei City (TW); Jia-Hong LIOU, Taipei City (TW)

(21) Appl. No.: 19/167,748

(22) PCT Filed: Apr. 2, 2024
(86) PCT No.: PCT/US2024/022654

§ 371 Date: Sep. 22, 2025

Related U.S. Application Data
(60) Provisional application No. 63/457,917, filed on Apr. 7, 2023.

(51) Int. Cl. H04L 69/322; H04L 47/722

(52) U.S. Cl. CPC H04L 69/322; H04L 47/722

(57) ABSTRACT

This disclosure provides systems, devices, apparatus, and methods, including computer programs encoded on storage media, for scheduling a delay sensitive data transmission. A UE (102) receives (310a/310b), from a network entity (104), an uplink grant for a MAC PDU. The MAC PDU includes a first allocation of logical channel priority with PBR data and a second allocation of remaining resources for residual data. The UE (102) transmits (316), to the network entity (104), the MAC PDU (316) with the second allocation of the remaining resources prioritizing urgent data in a logical channel buffer over the logical channel priority.

### CROSS REFERENCE TO RELATED APPLICATION(S)

This application claims the benefit of and priority to U.S. Provisional Application Ser. No. 63/457,917, entitled “Scheduling a Delay Sensitive Data Transmission” and filed on Apr. 7, 2023, which is expressly incorporated by reference herein in its entirety.

### TECHNICAL FIELD

The present disclosure relates generally to wireless communication, and more particularly, to scheduling delay sensitive data transmissions.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a medium access control (MAC) entity implement techniques to balance resource allocation among higher priority logical channels and lower priority logical channels. However, resource allocations for the logical channels may be associated with other characteristics besides the logical channel priority.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A logical channel prioritization procedure includes allocating resources to logical channels in decreasing order of priority of the logical channels to construct a medium access control (MAC) protocol data unit (PDU) for transmission from a user equipment (UE) to a network entity. The MAC PDU includes data from logical channel buffers of the logical channels. The UE allocates the data from the logical channel buffers to the MAC PDU in multiple stages. For example, in a first stage, the UE allocates the data to the MAC PDU based on a prioritized bit rate (PBR), sometimes also called Guaranteed Bit Rate (GBR), for the individual logical channels, starting with the logical channel of highest priority and continuing with the data allocation in decreasing order of priority of the logical channels, pending available resources for the MAC PDU to receive the continued data allocation from each of the logical channels. The PBR provides an upper bound on the amount of data that the UE can allocate to the MAC PDU from the individual logical channel buffers during the first stage of allocation.

If, after the first stage of allocation, the MAC PDU has remaining resources available to carry additional data, the UE performs a second stage of allocation that may fill the remaining/residual resources of the MAC PDU. For example, in the second stage, the UE again allocates data to the MAC PDU from the logical channel buffers in decreasing order of priority of the logical channels. Allocation of the data to the MAC PDU during the second stage may be without regard to the PBR/token bucket sizes of the logical channels. Thus, if the logical channel of highest priority has a large amount of data pending in the buffer during the second stage, the logical channel of highest priority can consume the residual resources of the MAC PDU without giving the other logical channels an opportunity to further reduce the amounts of data pending in their respective buffers.

In some examples, lower priority logical channels may have urgent data in their buffers when higher priority logical channels do not have any urgent data in their respective buffers. However, based on the above-described logical channel prioritization procedure, the UE would allocate non-urgent data from the higher priority logical channels to the MAC PDU during the second stage of allocation before allocating urgent data from the lower priority logical channels, which may increase the probability of missing a delivery deadline for the urgent data in the lower priority logical channel buffers. “Urgent data” refers to data with a remaining validity time that is less than or equal to a first threshold, or data with a queueing delay that is greater than or equal to a second threshold, etc.

Aspects of the present disclosure address the above-noted and other deficiencies by implementing a procedure that adds an urgent data factor to the existing factor regarding the priorities of the logical channels. For example, if the MAC PDU includes residual resources after the first round of allocation, the UE allocates the residual resources to the pending urgent data in order to prioritize transmission of the urgent data of those logical channel buffers over non-urgent data in higher priority logical channel buffers. The allocation of the residual resources may occur in decreasing order of priority of the logical channels that have the urgent data pending in the buffer or in decreasing order of a data loss rate of the logical channels that have the urgent data pending in the buffer. “Data loss rate” refers to an amount of data dropped from a logical channel buffer over time.

According to some aspects, the UE receives, from the network entity, an uplink grant to transmit the MAC PDU. The MAC PDU includes a first allocation of logical channel priority with PBR data and a second allocation of remaining resources for residual data. The UE transmits, to the network entity, the MAC PDU with the second allocation of the remaining resources prioritizing the urgent data in a logical channel buffer over the logical channel priority.

According to some aspects, the network entity transmits, to the UE, the uplink grant for the MAC PDU, as described above. The network entity receives, from the UE, the MAC PDU with the second allocation of the remaining resources prioritizing the urgent data of the logical channel buffer over the logical channel priority.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 is a diagram that illustrates logical channel prioritization at a medium access control (MAC) layer.

FIG. 3 illustrates a signaling diagram for a MAC protocol data unit (PDU) transmission based on an allocation of resources for delay sensitive data.

FIG. 4 illustrates a diagram of a MAC PDU data allocation based on logical channels with different logical channel priorities.

FIG. 5 illustrates a diagram of a MAC PDU data allocation based on a set of logical channels that have a same logical channel priority.

FIG. 6 is a flowchart of a method of wireless communication at a UE.

FIG. 7 is a flowchart of a method of wireless communication at a network entity.

FIG. 8 is a diagram illustrating a hardware implementation for an example UE apparatus.

FIG. 9 is a diagram illustrating a hardware implementation for one or more example network entities.

### DETAILED DESCRIPTION

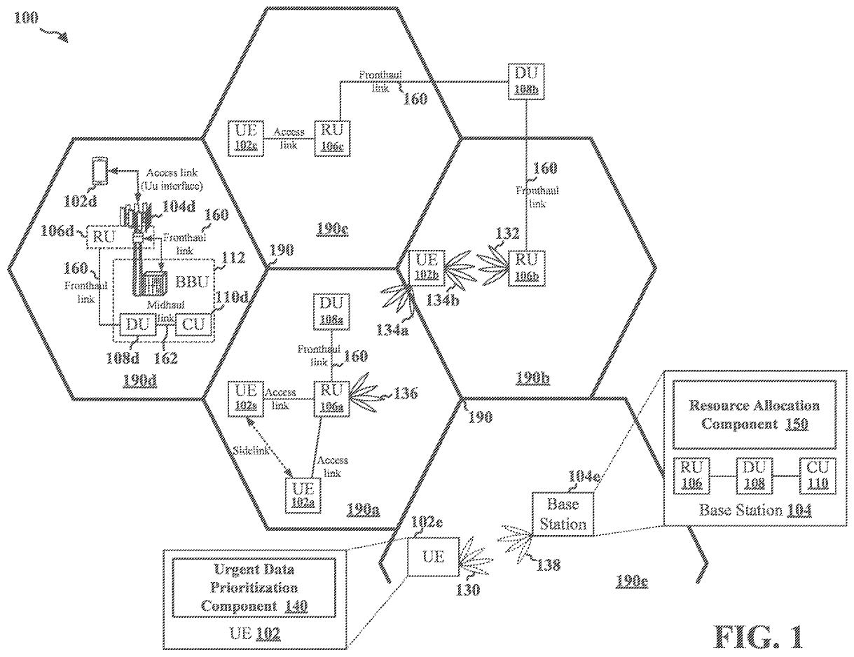

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the DUs 108a, 108b, 108d communicate with the RUs 106a-106d via fronthaul links 160. The base stations 104d/104e and/or the RUs 106a-106d communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108d and a CU 110d, which may also have a wired interface (e.g., midhaul link 162) configured between the DU 108d and the CU 110d to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The DU 108 is a logical unit of the base station 104 configured to perform one or more base station functionalities. The DU 108 can control the operations of one or more RUs 106. For example, the DU 108b controls the operations of multiple RUs 106b-106c, whereas the DU 108a controls the operations of a single RU 106a. The DU 108d also controls the operation of a single RU 106d. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower PHY layer or module may be implemented based on an interface for communications with other layers and modules hosted at the DU 108.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR 2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FRI is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 may or may not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106d and a BBU 112 that includes a DU 108d and a CU 110d, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node. In other examples, the UE 102b operates in DC with the DU 108a and the DU 108b. In such cases, the DU 108b can be the master node and the DU 108a can be the secondary node.

Still referring to FIG. 1, in certain aspects, any of the UEs 102 may include an urgent data prioritization component 140 configured to receive, from a network entity, an uplink grant to transmit a medium access control (MAC) protocol data unit (PDU), the MAC PDU including a first allocation of logical channel priority with prioritized bit rate (PBR) data and a second allocation of remaining resources for residual data; and transmit, to the network entity, the MAC PDU with the second allocation of the remaining resources prioritizing urgent data in a logical channel buffer over the logical channel priority.

In certain aspects, any of the base stations 104 or a network entity of the base stations 104 may include a resource allocation component 150 configured to transmit, to a UE, a first uplink grant for a MAC PDU including a first allocation of logical channel priority with PBR data and a second allocation of remaining resources for residual data; and receive, from the UE, the MAC PDU with the second allocation of the remaining resources prioritizing urgent data in a logical channel buffer over the logical channel priority.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

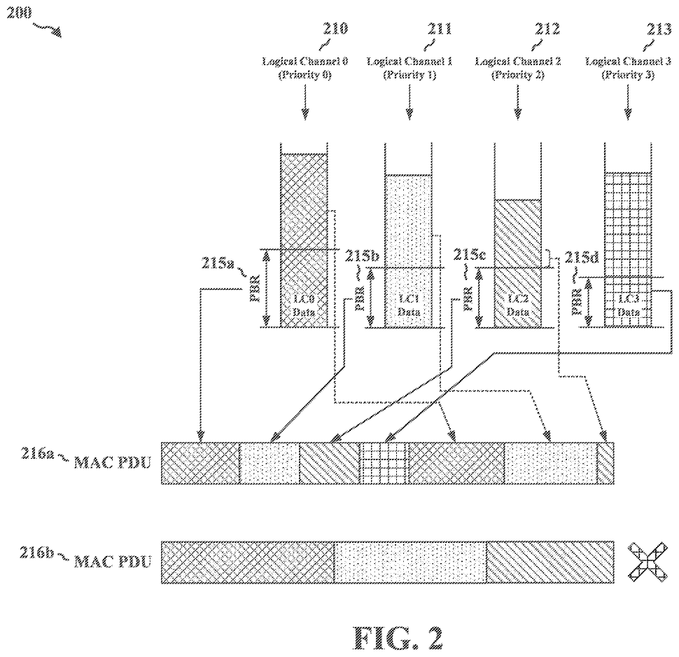

FIG. 2 is a diagram 200 that illustrates logical channel prioritization at a MAC layer. A data transmission process may be based on multiple logical channels 210-213 that carry data through multiple MAC PDUs. If the amount of data in buffer(s) of the logical channels 210-213 exceeds a transmission capacity of a MAC PDU 216, then the data in the logical channel buffers will not fit (e.g., in their entirety) within a single MAC PDU 216. Hence, a scheduling entity may determine which logical channel data to provide to the MAC PDU 216 for transmission, and which other logical channel data may remain in the buffer(s) of the logical channel(s) 210-213 for future transmission at a different MAC PDU transmission occasion.

A UE generates a MAC PDU 216 according to a predefined protocol that allows the UE to satisfy a quality of service (QOS) for each configured radio bearer. The UE determines the amount of data to incorporate for each logical channel 210-213 into a current MAC PDU 216 based on an uplink resource grant signaled to the UE on a physical downlink control channel (PDCCH). The UE may also allocate resources for a MAC-control element (MAC-CE) within the MAC PDU 216. The UE performs a logical channel prioritization procedure for each MAC PDU transmission. “Logical channel prioritization” refers to incorporating data into the MAC PDU 216 from the different logical channels 210-213 based on priority values of the different logical channels 210-213.

If MAC resources are not large enough to accommodate the logical channel data from all of the logical channel buffers, the UE allocates MAC resources based on a priority level for each logical channel 210-213. For example, a radio resource control (RRC) parameter indicates the priority level of each logical channel 210-213, where priority 0 is a highest priority, priority 1 is a next highest priority, and so on. The diagram 200 includes four logical channels 210-213 that correspond to logical channel 0 210 having priority 0, logical channel 1 211 having priority 1, logical channel 2 212 having priority 2, and logical channel 3 213 having priority 3. Each logical channel 210-213 is associated with a logical channel buffer that includes data waiting for transmission in the MAC PDU 216.

In a first implementation of the MAC PDU 216b, the UE incorporates logical channel data into the MAC PDU 216b based on a descending order of priority of the logical channels 210-213, beginning with priority 0, until all of the available MAC PDU resources are allocated. For instance, the MAC PDU 216b accommodates the data from the logical channel buffer of logical channel 0 210, logical channel 1 211, and logical channel 2 212, but does not have enough remaining resources available to accommodate the data for logical channel 3 213. Hence, the data for logical channel 3 213 may remain in the buffer of logical channel 3 213 until a future MAC PDU has available space to transmit the data from logical channel 3 213. If no further data flows into the buffers of higher priority logical channels 0, 1, 2 210-212, the data for logical channel 3 213 may be incorporated into a next MAC PDU transmission.

While strict logical channel prioritization may be sufficient in many instances, if data continues to flow into higher priority logical channels 0, 1, 2 210-212 before each MAC PDU transmission instance, the data held in the buffer for logical channel 3 213 may experience “starvation”. That is, the data in logical channel 3 213 is repeatedly passed over for incorporation into MAC PDU transmissions in favor of higher priority bearers. “Starvation” refers to lower priority data that cannot be transmitted over an extended time duration because higher priority data repeatedly consumes the available MAC PDU transmission resources without allowing the lower priority data to be incorporated into subsequent versions of the MAC PDU 216b for transmission.

To avoid starvation while still serving the logical channels 210-213 based on priority levels, a second implementation of the MAC PDU 216a uses a PBR 215 (e.g., configured via RRC) to set a data rate for higher priority logical channels that limits resources allocated to the higher priority logical channels before resources begin to be allocated to the lower priority logical channels. Such techniques reduce starvation of lower priority data, even if high priority data continues to flow into the logical channel buffer of higher priority logical channels. Thus, this implementation uses two stages for allocating data from multiple logical channels. Each logical channel 210-213 may be configured with an independent PBR 215. For example, the PBR 215a of logical channel 0 210 with priority 0 can be larger than the PBR 215b of logical channel 1 211 with priority 1. In another example, the PBR 215b of logical channel 1 211 with priority 1 equals the PBR 215c of logical channel 2 212 with priority 2. Lower priority logical channels, such as logical channel 3 213 generally have a PBR 215d that is less than or equal to the PBR 215a-215c of higher priority logical channels, such as the logical channels 0, 1, 2 210-212.

In the second implementation of the MAC PDU 216a, the UE serves each logical channel 210-213 in decreasing order of priority to account for both the PBR 215 and the priority value of the logical channels 210-213. The amount of data from each logical channel 210-213 included in the MAC PDU 216a is initially limited based on the PBR 215 of each logical channel 210-213. If all of the logical channels 0, 1, 2, 3 210-213 have been served up to their respective PBRs 215, then each logical channel 0, 1, 2, 3 210-213 can be served again in decreasing priority until the logical channels 210-213 have no more data remaining in their buffers or until all of the available MAC PDU resources are exhausted (as illustrated for the MAC PDU 216a), whichever comes first.

RRC parameters may control the scheduling of uplink data from each logical channel 210-213, by setting parameters for the PBRs 215, setting a bucket size duration (BSD) for data transmission tokens, and/or indicating that increasing priority values correspond to decreasing levels of priority. Data transmission tokens and a token buckets algorithm prioritizes various logical channel transmissions, as described further below. The UE can maintain variable token bucket sizes (Bj) for each logical channel j. The token bucket size (Bj) is initialized to zero when the corresponding logical channel is established, and incremented by a product of PBR×TTI duration for each TTI, where the PBR 215 corresponds to logical channel j. A value of Bj cannot exceed the token bucket size (e.g., more tokens than the bucket can hold) and is, thus, limited to the token bucket size of each logical channel j. The bucket size of a logical channel 210-213 is equal to PBR×BSD, where PBR and BSD are configured based on upper layer parameters.

A MAC-CE included in the MAC PDU 216 may have a higher priority than any of the logical channels 210-213, because the MAC-CE controls operations of a MAC entity. Thus, when the UE generates a MAC PDU 216, the MAC-CE may be included in the MAC PDU 216 first (not shown), such that the UE allocates the remaining space in the MAC PDU 216 to data from the logical channel buffer of the logical channels 210-213. An exception may be when the UE transmits a first RRC message to a target cell during a handover procedure. In such cases, a MAC-CE, such as a buffer status report (BSR), can have a lower priority than the signaling radio bearers (SRBs), so that the handover procedure can be completed sooner, rather than later. Otherwise, a data transfer interruption time might be extended and a probability of a handover failure might increase as a result of delayed signaling.

Even in examples where higher priority logical channels are configured with a PBR 215, the lower priority channels/data may still experience starvation if the higher priority channels are associated with large PBRs 215/large amounts of data that consume the available MAC PDU resources before all of the logical channels 210-213 have received an allocation. Hence, in a third implementation of the MAC PDU 216, data from the logical channels 210-213 may be incorporated into the MAC PDU 216 based on techniques that balance the PBRs 215 against instances of starvation of low priority data.

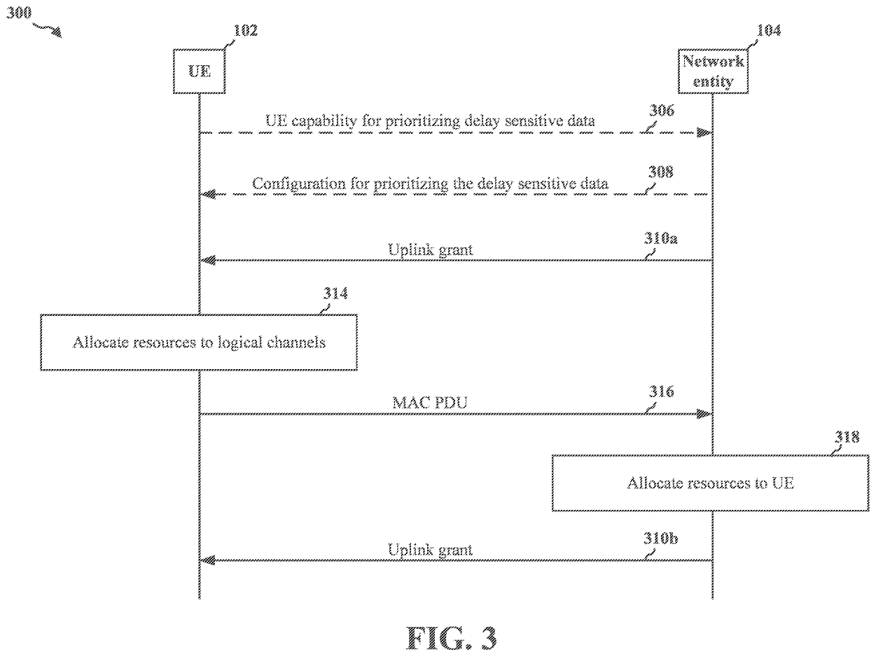

In an example, the priority 3 data for logical channel 3 213 might be included in the MAC PDU 216 even if higher priority logical channels (e.g., 210-212) have data in buffers. The third implementation of the MAC PDU 216 may be based on a timing duration/restriction for the logical channels 210-213 according to priority. Each logical channel 210-213 may be associated with a countdown timer, such that each time a logical channel 210-213 transmits an amount of data equal in size to the PBR 215 for the logical channel 210-213, the timer is decreased by 1. If the countdown timer becomes negative, the higher priority logical channel cedes its opportunity to transmit data in an upcoming MAC PDU to a lower priority logical channel. Thus, the countdown timer prevents higher priority logical channels from monopolizing the MAC PDUs 216, even if the high priority logical channels have data to transmit (e.g., with large PBRs). The countdown timer may be configured based on an RRC parameter for bucketSizeDuration. FIG. 2 describes how logical channel data is incorporated into a MAC PDU 216. FIG. 3 illustrates how resources are granted to the UE for a MAC PDU transmission.

FIG. 3 illustrates a signaling diagram 300 for a MAC PDU transmission based on an allocation of resources for delay sensitive data. A system capacity, such as for extended reality (XR) systems, can be a performance indicator that refers to a maximum number of UEs per cell with at least Y % of the UEs having all of their data streams satisfying a packet error rate (PER) and a packet delay budget (PDB). That is, the UEs transmit (i.e., do not drop) more than a certain percentage of packets over an air interface. An example percentage may be Y=90-95%. However, other values of Y are contemplated.

A UE 102 determines a size of a MAC PDU associated with an uplink grant when the UE 102 receives the uplink grant from a network entity 104. Based on the size of the MAC PDU, the UE 102 allocates resources (e.g., in bytes) to one or more logical channels according to the bucket sizes of the “token buckets” for the one or more logical channels as well as the priority levels of the one or more logical channels. The token buckets may be denoted as Bj, which refers to a bucket size of logical channel j. For each logical channel j, a MAC entity increments Bj by a product of PBR×T before each instance of a logical channel prioritization (LCP) procedure, where T corresponds to an elapsed time since Bj was last incremented. If a value of Bj is greater than the bucket size (e.g., greater than PBR×BSD), the value of Bj is set to the bucket size. A maximum size of a token bucket is equal to PBR×BSD.

The UE 102 allocates a number of bytes to transmit a radio link control (RLC) service data unit (SDU) from a logical channel, if the value of Bj for the logical channel includes at least a number of bytes equal to a size of an RLC PDU. Hence, the number of bytes that the UE 102 can allocate for a logical channel is be based on Bj (e.g., a size of the token bucket). In examples, the MAC entity allocates resources to logical channels for logical channel transmissions based on the logical channels selected for the uplink grant with Bj>0 being allocated resources in a decreasing priority order. If the PBR of a logical channel is set to infinity, the MAC entity allocates resources for all of the data that is available for transmission on that logical channel before allocating resoruces for the PBR of the lower priority logical channel(s). The MAC entity decrements Bj by the total size of the MAC SDUs served to logical channel j. If any resources remain for allocation, the logical channels may be served in a decreasing priority order, regardless of the value of Bj, until either the data for the logical channels is exhausted or the uplink grant is exhausted, whichever comes first. Logical channels configured with equal priority may be served equally.

An LCP procedure includes allocating resources to logical channels (e.g., a number of bytes to transmit to the network entity 104) in decreasing priority order of the logical channels for transmission of a MAC PDU. The UE 102 may implement the resource allocation in two stages as previously described with reference to MAC PDU 216a.

If, however, the highest priority logical channel has a large amount of data pending in the buffer during the second stage of allocation, the highest priority logical channel can consume the remaining/residual resources of the MAC PDU without giving the other/lower priority logical channels an opportunity to further reduce the amounts of data pending in their respective buffers. In some examples, lower priority logical channels have urgent data pending in the buffer when higher priority logical channels do not have any urgent data in their buffers. However, the UE may allocate the non-urgent data of the higher priority logical channels during the second stage of allocation before allocating the urgent data of the lower priority logical channels, which may increase the probability of missing a delivery deadline for the urgent data in the lower priority logical channel buffers and potentially lead to a high data drop rate that does not satisfy system capacity protocols.

The UE 102 may implement techniques, such as illustrated in the diagram 300, that adds urgent data prioritization to the LCP procedure. “Urgent data”, which may also be called “delay sensitive data”, refers to data with a remaining validity time that is less than or equal to a first threshold and/or data with a queueing delay that is greater than or equal to a second threshold. An example of the first threshold for the remaining validity time may be 20 ms. Examples of the second threshold for the queueing delay may be for application control, pose information, etc. For instance, control information can have a larger threshold than data in different logical channels, which may thereby result in the control information having a higher priority than data that has a same remaining validity time. The UE 102 may transmit 306 UE capability information to the network entity 104 indicating a UE capability for prioritizing delay sensitive data for a MAC PDU transmission.

The network entity 104 transmits 308 to the UE 102 (e.g., based on the UE capability) a configuration for prioritizing the delay sensitive data for the MAC PDU transmission. The configuration may indicate parameters such as a prioritisedBitRate that sets the PBR for the logical channels, a bucketSizeDuration that sets the BSD for the logical channels, a threshold criterion for determining which data in the buffer is urgent, etc. The configuration may include an indication that enables or disables the UE from prioritizing the delay sensitive data. The network entity 104 may transmit 308 the configuration to the UE 102 in an RRC message, such as an RRC reconfiguration message, an RRC setup message, an RRC reestablishment message, or an RRC resume message. In further examples, the network entity 104 may transmit 308 the configuration to the UE in a system information message. In other examples, the first threshold and/or the second threshold are predefined values.

The network entity 104 transmits 310 an uplink grant to the UE 102 for the UE 102 to determine a size of the MAC PDU. For example, the network entity 104 transmits 310a a first uplink grant to the UE 102 for the UE to allocate 314 resources to the logical channels. The UE 102 may receive 310 the uplink grant from the network entity 104 in downlink control information (DCI) on a PDCCH, in a random access response (RAR) message during a random access procedure, or in an RRC message such as an RRCReconfiguraiton message or an RRCRelease message. In further examples, the uplink grant is stored in memory of the UE 102, from which the UE 102 acquires the uplink grant according to a periodicity configured by the network entity 104.

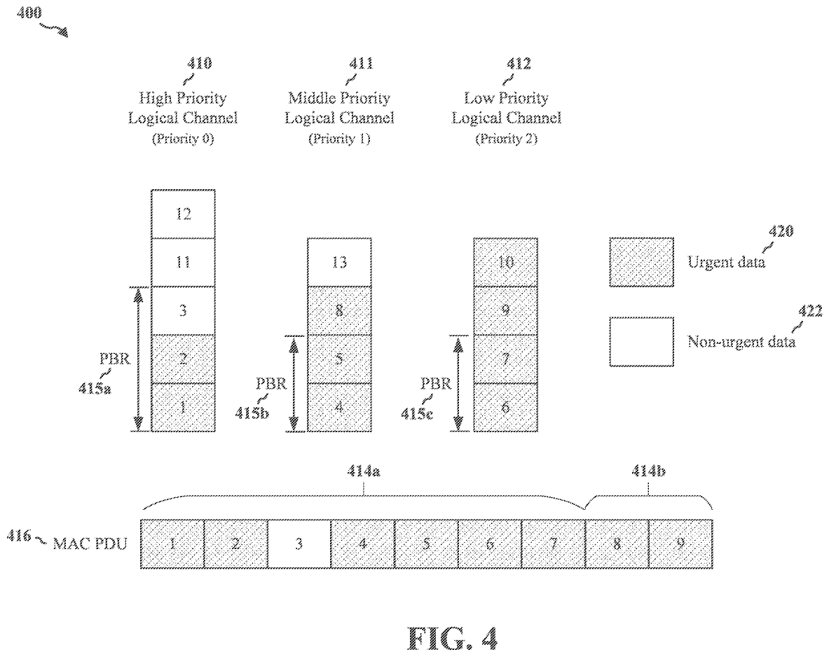

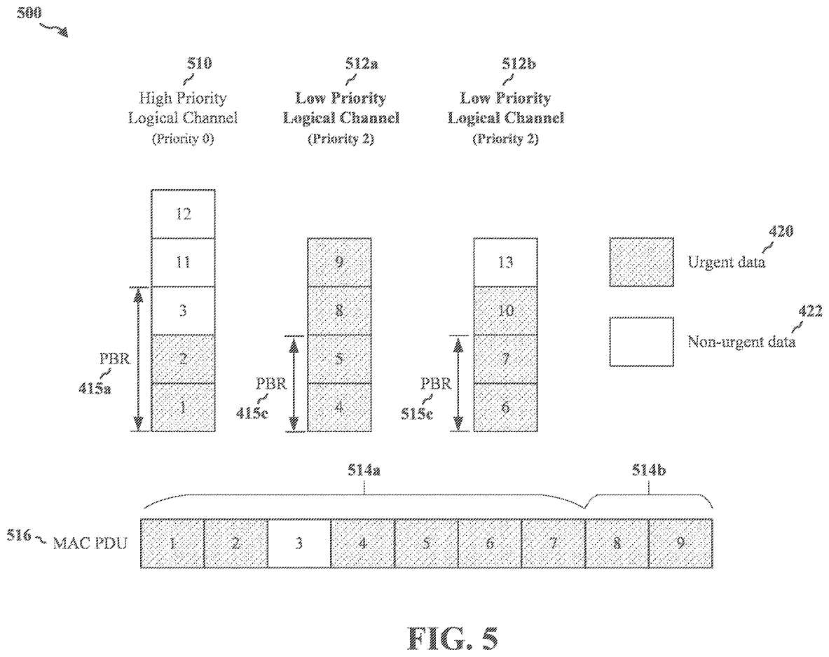

The UE 102 allocates 314 the MAC PDU resources to the logical channels in multiple stages. For example, as described above, the UE 102 allocates 314 resources to the logical channels in the first stage with bucket size>0 in decreasing priority order of the logical channels and then decrements the bucket size by the number of resources allocated to the logical channel (e.g., by the number of bits to be transmitted). For the LCP procedure that adds the urgent data prioritization, the UE 102 performs an intermediate stage of allocation between the first stage and the second stage described previously. During the intermediate stage, the UE 102 allocates 314 resources based on techniques that prioritize urgent data in a lower-priority logical channel buffer over non-urgent data in a higher-priority logical channel buffer. The intermediate stage of allocation is described in further detail below with respect to FIGS. 4-5.

If, after the intermediate stage of allocation, which may be regarded as the second stage of allocation in the LCP procedure that adds the urgent data prioritization, the MAC PDU still has remaining resources available to carry additional data, the UE 102 performs another stage/third stage of allocation to allocate 314 the remaining resources to the logical channels in decreasing priority order (e.g., regardless of the value of Bj) until either the data for each logical channel is exhausted or the remaining resources are exhausted, whichever comes first. The third stage of allocation for the LCP procedure that adds the urgent data prioritization is similar to the second stage of allocation, described above with reference to MAC PDU 216a, for the LCP procedure that does not include the intermediate stage for urgent data prioritization.

The UE 102 transmits 316 the MAC PDU to the network entity 104 based on the allocation 314 of resources to the logical channels. The MAC PDU can include delay information and/or data volume information indicating the amount of urgent data currently pending in the logical channel buffers. If the remaining validity time of data in the logical channel buffer is less than or equal to the first threshold (e.g., 20 ms), the UE 102 prioritizes that data for transmission in the MAC PDU. Likewise, if the queueing delay for the same or different data currently pending in the logical channel buffer is greater than or equal to the second threshold, the UE 102 also prioritizes that data for transmission in the MAC PDU. In some examples, the second threshold corresponds to the time between when the UE 102 transmits the delay information of the data and when the UE 102 transmits the data. The UE 102 may determine/compute the data volume information for a channel, a channel group, and/or a PDU set (i.e., a set of data). Data in a same PDU set has a same delay budget and a same delivery deadline. “Data volume” refers to a sum of the sizes of data in buffer for all of the logical channels that would be included in a MAC PDU transmission, pending available space in the MAC PDU, based on the LCP procedure that adds the urgent data prioritization.

The network entity 104 may process the information included in the MAC PDU to allocate 318 resources to the UE 102. For example, the network entity 104 transmits 310b a second uplink grant to the UE 102 that grants the UE 102 a sufficient amount of resources to transmit a second MAC PDU (not shown) large enough to carry all the urgent data indicated 316 via the first MAC PDU as currently pending in the logical channel buffer of all the logical channels. The network entity 104 also maintains token buckets for the logical channels and updates the token buckets in a similar manner to the UE 102. The size of the second MAC PDU may correspond to a sum of the current token bucket sizes of all the logical channels plus a sum of the differences between the current token bucket sizes and the data volume for the logical channels. That is, the size of the second MAC PDU may be equal to (or greater than) the sum of the data associated with the first stage and the intermediate stage of allocation. FIG. 3 describes a MAC PDU transmission based on an LCP procedure with the urgent data prioritization. FIGS. 4-5 show data allocations within the MAC PDU according to the LCP procedure with the urgent data prioritization.

FIGS. 4-5 illustrate diagrams 400-500 of data allocations 414a-414b/514a-514b from a logical channel buffer of logical channels (410-412, 510-512b) to a MAC PDU 416/516. Referring to FIG. 4, the diagram 400 illustrates three logical channel buffers for three logical channels 410-412 of different priorities. In particular, the diagram 400 illustrates a high priority logical channel 410 of priority 0, a middle priority logical channel 411 of priority 1, and a low priority logical channel 412 of priority 2. The logical channels 410-412 are associated with respective PBRs 415, where a first PBR 415a of the high priority logical channel 410 is larger than a second PBR 415b of the middle priority logical channel 411 and a third PBR 415c of the low priority logical channel 412.

In the first stage of allocation 414a, the UE allocates data to the MAC PDU 416 from the logical channel buffers according to the PBRs 415 in decreasing priority order of the logical channels 410-412. Thus, the first stage of allocation 414a begins with the first PBR 415a of the high priority logical channel 410, where the UE allocates data packets 1, 2, and 3 to the MAC PDU 416. After the first PBR 415a is satisfied, the UE allocates data packets 4 and 5 to the MAC PDU 416 according to the second PBR 415b of the middle priority logical channel 411. To conclude the first stage of allocation 414a, the UE allocates data packets 6 and 7 to the MAC PDU 416 according to the third PBR 415c of the low priority logical channel 412. The UE allocates the data packets from the logical channel buffers in the first stage of allocation 414a regardless of whether the data packets correspond to urgent data 420 or non-urgent data 422.

In the second stage of allocation 414b (also referred to herein as the intermediate stage of allocation for LCP procedures that add the urgent data prioritization), if there are remaining resources in the MAC PDU 416 after the first stage of allocation 414a to carry additional data, the UE may allocate the remaining resources to the urgent data 420 that is still pending in the logical channel buffer of the logical channels 410-412 in decreasing priority order of the logical channels 410-412 (e.g., regardless of token bucket sizes). Thus, the second stage of allocation 414b begins with the urgent data 420 for the middle priority logical channel 411, because the high priority logical channel 410 does not have any urgent data 420 still remaining in the logical channel buffer after the first stage of allocation 414a. Proceeding in decreasing priority order, the middle priority logical channel 411 has one data packet of urgent data 420 (i.e., data packet 8) still remaining in the logical channel buffer during the second stage of allocation 414b. Thus, the UE 102 allocates data packet 8 to the MAC PDU 416 and leaves data packet 13 pending in the buffer, because data packet 13 is non-urgent data 422. To conclude the second stage of allocation 414b, the UE allocates urgent data 420 data packet 9 to the MAC PDU 416 from the low priority logical channel 412, because data packet 9 is the next head-of-line data packet to be allocated from the logical channel buffer. Although the low priority logical channel 412 has another urgent data packet in buffer (i.e., data packet 10), the MAC PDU 416 does not have available space to carry another urgent data packet and, therefore, data packet 10 is not included in the MAC PDU 416 during the second stage of allocation 414b.

In an alternative implementation (not shown), if the MAC PDU 416 was large enough to carry all 13 data packets illustrated in the diagram 400 in the logical channel buffer of the three different logical channels 410-412, data packet 10 (which is urgent data 420) would be included next in the MAC PDU 416 during the second stage of allocation 414b. Then, the LCP procedure would proceed to a third stage of allocation (not shown) in which the UE would allocate the non-urgent data 422 still remaining in the logical channel buffer, such as in decreasing priority order of the logical channels 410-412. That is, the UE would allocate data packets 11 and 12 to the MAC PDU 416 from the high priority logical channel 410, followed by data packet 13 from the middle priority logical channel 411.

The UE may also transmit a MAC-CE (not shown) in the MAC PDU 416/516. The UE may prioritize transmission of urgent data 420 over non-urgent MAC-CEs. For example, the UE prioritizes the urgent data 420 over a non-urgent MAC-CE for at least one of: (enhanced) beam failure recovery (BFR), (sidelink/multiple entry) configured grant confirmation, listen-before-talk (LBT) failure, timing advance reports, sidelink/extended BSRs, (enhanced) single/multiple entry power headroom reports (PHRs), positioning measurement gap activation/deactivation requests, a number of desired guard symbols, timing requests, (extended) pre-emptive BSRs, IAB-mobile termination (MT) recommended beam indication, a desired IAB-MT power spectral density (PSD) range, a desired downlink transmit (Tx) power adjustment, a recommended bit rate query, or padding BSRs. In some examples, the UE prioritizes transmission of data volume information over transmission of urgent data 420. That is, transmission of delay information has a higher priority than transmission of urgent data 420.

Referring to FIG. 5, the diagram 500 illustrates three logical channel buffers for three logical channels 510-512b, where two of the logical channels are low priority logical channels 512a-512b with a same priority level. The high priority logical channel 510 of priority 0 has the first PBR 415a, the first low priority logical channel 512a of priority 2 has the second PBR 415c, and the second low priority logical channel 512b of priority 2 also has a low priority PBR 515c similar to second PBR 415c.

In the first stage of allocation 514a, the UE allocates data to the MAC PDU 516 from the logical channel buffers according to the PBRs 415a, 415c, 515c in decreasing priority order of the logical channels 510-512b in a similar manner as described with respect to FIG. 4. The first stage of allocation 514a is independent of whether the data being allocated to the MAC PDU 516 is urgent data 420 or non-urgent data 422.

When logical channels, such as the two low priority logical channels 512a-512b have the same logical channel priority, the UE can consider other criteria to determine which of the logical channels 512a-512b to allocate resources to first during the second stage of allocation 514b. For example, if two logical channels are of the same priority level, and both logical channels have urgent data 420 remaining in the buffer during the second stage of allocation 514b, the UE can allocate resources first to the logical channel 512a-512b having the head-of-line data with the shortest remaining validity time. Thus, if data packet 8 (i.e., the head-of-line data packet for the first low priority logical channel 512a during the second stage of allocation 514b) has a shorter remaining validity time than data packet 10 (i.e., the head-of-line data packet for the second low priority logical channel 512b during the second stage of allocation 514b), then the UE would prioritize the urgent data 420 for the first low priority logical channel 512a over the urgent data 420 for the second low priority logical channel 512b.

In further examples, the UE allocates resources to the logical channel 512a-512b with a larger volume of urgent data 420 remaining in a buffer. In the diagram 500, the first low priority logical channel 512a has a larger volume of urgent data 420 (i.e., two data packets) remaining in the buffer during the second stage of allocation 514b than the second low priority logical channel 512b (i.e., 1 data packet) during the second stage of allocation 514b. Thus, the UE may prioritize the resource allocation for the first low priority logical channel 512a over the second low priority logical channel 512b. Conversely, the UE allocates resources to the logical channel 512a-512b with a smaller volume of urgent data 420 remaining in a buffer in another example.

In other examples, the UE implements a round-robin approach to the resource allocation. For example, if the UE allocates N transmit bytes to the first low priority logical channel 512a, the UE also allocates N transmit bytes to the second low priority logical channel 512b, and so on. The techniques described above with respect to the logical channels 512a-512b of same priority in the diagram 500 can also be applicable to the logical channels 410-412 of different priority described with respect to the diagram 400.

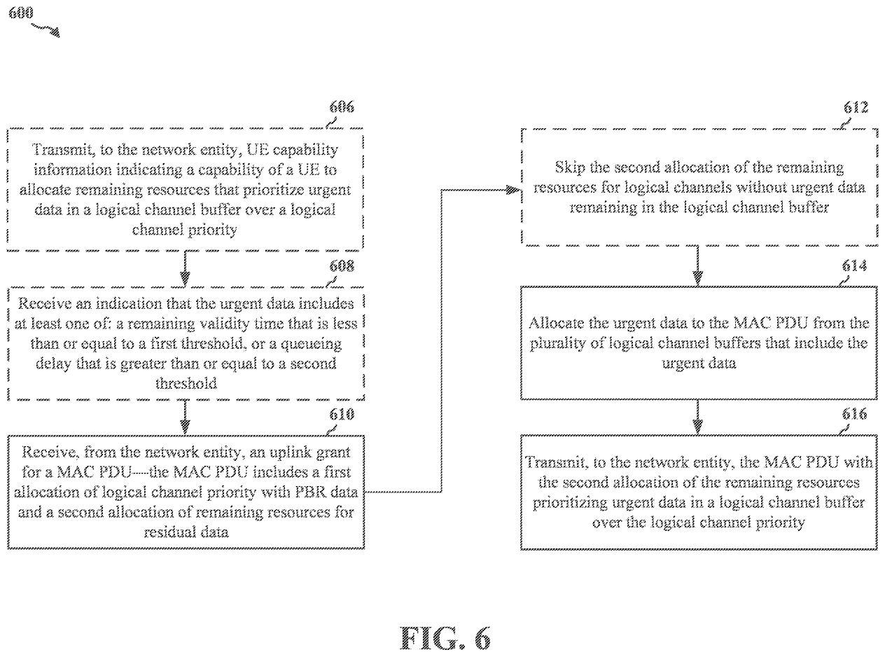

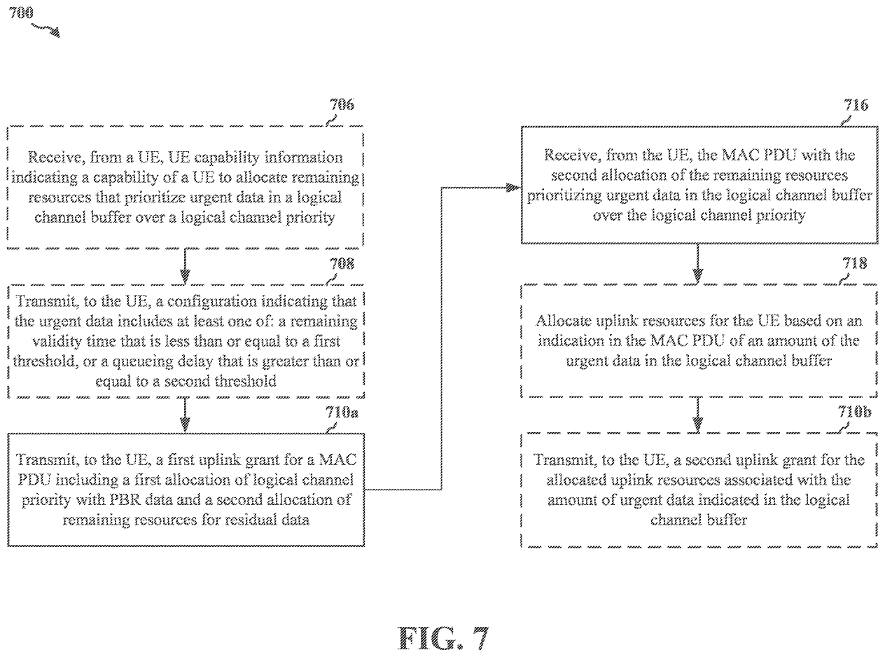

Referring to the diagrams 400-500, the UE can alternatively allocate resources during the second round of allocation 414b/514b to the logical channels 411-412, 512a-512b with urgent data 420 in the logical channel buffer in decreasing order of a measured data loss rate of the logical channels 411-412, 512a-512b. That is, the UE can allocate resources first to the logical channel 512a-512b with the highest amount of data/number of bytes dropped from the logical channel buffer over time (e.g., in comparison to the amount of data/total number of bytes that come into the buffer). The data loss rate can correspond to the number of bytes dropped from the logical channel buffer over the total number of bytes that comes into buffer, or as the number of SDUs dropped from the logical channel buffer over the total number of SDUs that comes into buffer. The UE allocates resources in decreasing priority order and/or in decreasing data loss rate order until either the urgent data 420 in the logical channel buffer is exhausted or the remaining MAC PDU resources is exhausted, whichever comes first. FIGS. 3-5 illustrate transmission of a MAC PDU based on a data allocation procedure that prioritizes transmission of urgent data 420. FIGS. 6-7 show methods for implementing one or more aspects of FIGS. 3-5. In particular, FIG. 6 shows an implementation by the UE 102 of the one or more aspects of FIGS. 3-5. FIG. 7 shows an implementation by the network entity 104 of the one or more aspects of FIGS. 3-5.

FIG. 6 illustrates a flowchart 600 of a method of wireless communication at a UE. With reference to FIGS. 1, 3, and 8, the method may be performed by the UE 102, the UE apparatus 802, etc., which may include the memory 826′, 806′, 816, and which may correspond to the entire UE 102 or the entire UE apparatus 802, or a component of the UE 102 or the UE apparatus 802, such as the wireless baseband processor 826 and/or the application processor 806.

The UE 102 transmits 606, to the network entity, UE capability information indicating a capability of a UE to allocate remaining resources that prioritize urgent data in a logical channel buffer over a logical channel priority. For example, referring to FIG. 3, the UE 102 transmits 306, to the network entity 104, a UE capability for prioritizing delay sensitive data.

The UE 102 receives 608 an indication that the urgent data includes at least one of: a remaining validity time that is less than or equal to a first threshold, or a queueing delay that is greater than or equal to a second threshold. For example, referring to FIG. 3, the UE 102 receives 308, from the network entity 104, a configuration for prioritizing the delay sensitive data.

The UE 102 receives 610, from the network entity, an uplink grant for a MAC PDU—the MAC PDU includes a first allocation of logical channel priority with PBR data and a second allocation of remaining resources for residual data. For example, referring to FIGS. 3-5, the UE 102 receives 310a/310b an uplink grant from the network entity 104. The diagrams 400-500 illustrate a MAC PDU 416/516 with a first stage of allocation 414a/514a based on the PBRs 415/515 for the logical channels 410-412, 510-512b and a second stage of allocation 414b/514b for remaining resources of the MAC PDU 416/516.

The UE 102 skips 612 the second allocation of the remaining resources for logical channels without urgent data remaining in the logical channel buffer. For example, referring to FIGS. 4-5, the second stage of allocation 414b/514b for the MAC PDU 416/516 does not include data allocated from the logical channel buffer of the high priority logical channel 410/510, as the high priority logical channel 410/510 is without urgent data 420 in the logical channel buffer during the second stage of allocation 414b/514b. That is, the logical channel buffer of the high priority logical channel 410/510 only has non-urgent data (i.e., data packets 11 and 12) pending in the logical channel buffer during the second stage of allocation 414b/514b.

The UE 102 allocates 614, the urgent data to the MAC PDU from the plurality of logical channel buffers that include the urgent data. For example, referring to FIGS. 3-5, the UE 102 allocates 314 the urgent data 420 to the MAC PDU 416/516 from the plurality of logical channel buffers during a second round of allocation 414b/514b. In some implementations, the UE 102 can perform a fixed allocation across the logical channels 510-512b in a round-robin manner. That is, the UE 102 may provide a fixed allocation of two data packets, where the UE 102 allocates two data packets (i.e., data packets 8 and 9) from the first low priority logical channel 512a, two data packets (i.e., data packets 10 and 13) from the second low priority logical channel 512b, and so on, in two packet-sized allocations until either the data in the logical channels or the available resources of the MAC PDU 516 is exhausted.

The UE 102 transmits 616, to the network entity, the MAC PDU with the second allocation of the remaining resources prioritizing urgent data in a logical channel buffer over the logical channel priority. For example, referring to FIGS. 3-5, the UE 102 transmits 316 the MAC PDU to the network entity 104. The MAC PDU 416/516 includes the second stage of allocation 414b/514b for the urgent data 420. FIG. 6 describes a method from a UE-side of a wireless communication link, whereas FIG. 7 describes a method from a network-side of the wireless communication link.

FIG. 7 is a flowchart 700 of a method of wireless communication at a network entity. With reference to FIGS. 1, 3, and 9, the method may be performed by one or more network entities 104, which may correspond to a base station or a unit of the base station, such as the RU 106, the DU 108, the CU 110, an RU processor 906, a DU processor 926, a CU processor 946, etc. The one or more network entities 104 may include memory 906′/926′/946′, which may correspond to an entirety of the one or more network entities 104, or a component of the one or more network entities 104, such as the RU processor 906, the DU processor 926, or the CU processor 946.

The network entity 104 receives 706, from a UE, UE capability information indicating a capability of a UE to allocate remaining resources that prioritize urgent data in a logical channel buffer over a logical channel priority. For example, referring to FIG. 3, the network entity 104 receives 306, to the UE 102, a UE capability for prioritizing delay sensitive data.

The network entity 104 transmits 708, to the UE, a configuration indicating that the urgent data includes at least one of: a remaining validity time that is less than or equal to a first threshold, or a queueing delay that is greater than or equal to a second threshold. For example, referring to FIG. 3, the network entity 104 transmits 308, to the UE 102, a configuration for prioritizing the delay sensitive data.

The network entity 104 transmits 710a, to the UE, a first uplink grant for a MAC PDU including a first allocation of logical channel priority with PBR data and a second allocation of remaining resources for residual data. For example, referring to FIG. 3, the network entity 104 transmits 310a a first uplink grant to the UE 102. The diagrams 400-500 illustrate a MAC PDU 416/516 with a first stage of allocation 414a/514a based on the PBRs 415/515 for the logical channels 410-412, 510-512b and a second stage of allocation 414b/514b for remaining resources of the MAC PDU 416/516.

The network entity 104 receives 716, from the UE, the MAC PDU with the second allocation of the remaining resources prioritizing urgent data in the logical channel buffer over the logical channel priority. For example, referring to FIG. 3, the network entity 104 receives 316 the MAC PDU from the UE 102. The MAC PDU 416/516 includes the second stage of allocation 414b/514b for the urgent data 420.

The network entity 104 allocates 718 uplink resources for the UE based on an indication in the MAC PDU of an amount of the urgent data in the logical channel buffer. For example, referring to FIG. 3, the network entity 104 may receive 316, from the UE 102, the MAC PDU with a MAC-CE that indicates the amount of urgent data in the logical channel buffer, such that the network entity 104 can allocate 318 resources to the UE 102 to accommodate the amount of urgent data in a next MAC PDU transmission.

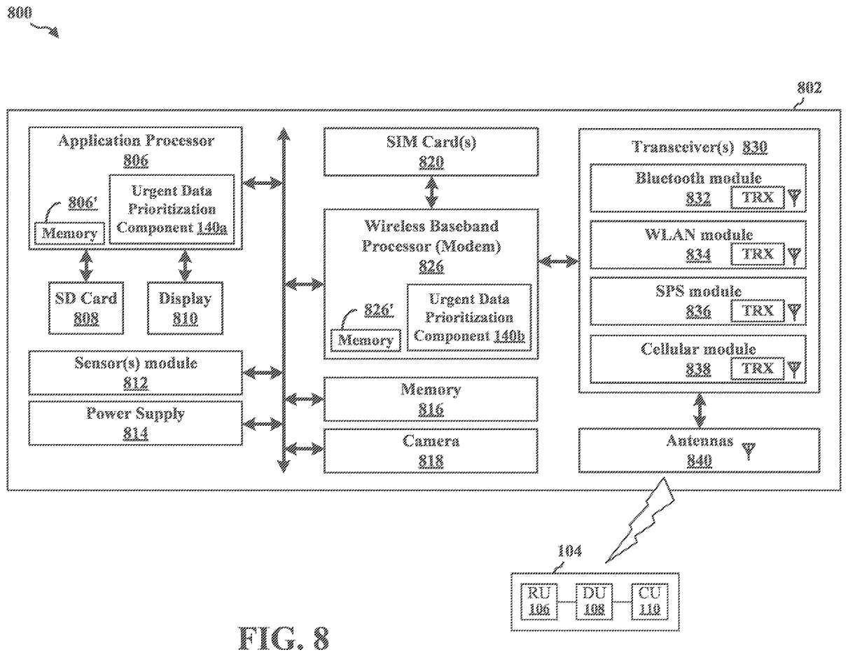

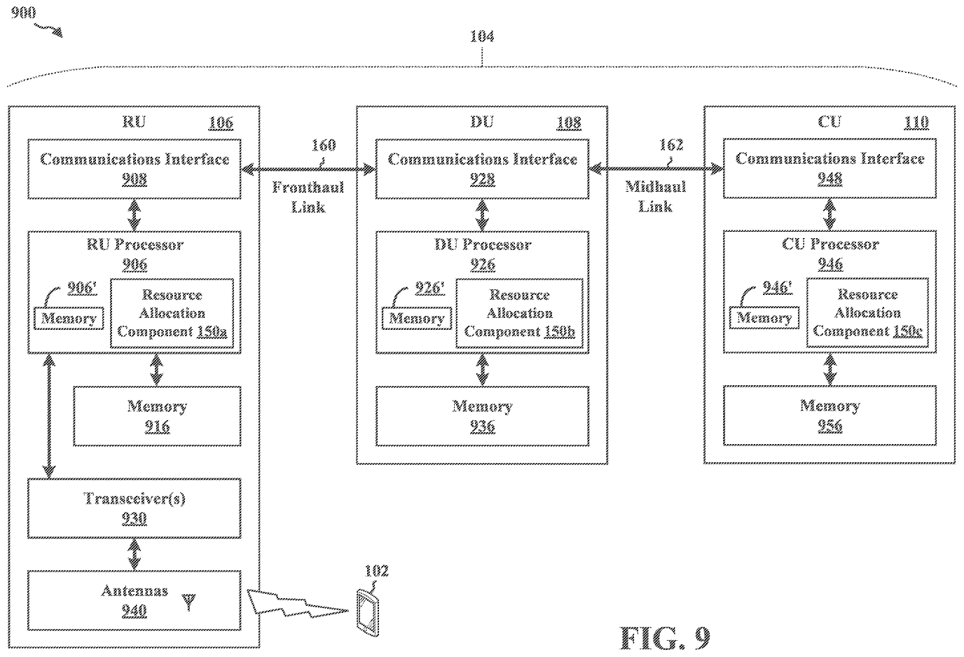

The network entity 104 transmits 710b, to the UE, a second uplink grant for the allocated uplink resources associated with the amount of urgent data indicated in the logical channel buffer. For example, referring to FIG. 3, the network entity 104 transmits 310b, to the UE 102, a second uplink grant for the resources allocated 318 to the UE 102 based on the indication received 316 in the MAC PDU of the amount of urgent data in the logical channel buffer. A UE apparatus 802, as described in FIG. 8, may perform the method of flowchart 600. The one or more network entities 104, as described in FIG. 9, may perform the method of flowchart 700.

FIG. 8 is a diagram 800 illustrating an example of a hardware implementation for a UE apparatus 802. The UE apparatus 802 may be the UE 102, a component of the UE 102, or may implement UE functionality. The UE apparatus 802 may include an application processor 806, which may have on-chip memory 806′. In examples, the application processor 806 may be coupled to a secure digital (SD) card 808 and/or a display 810. The application processor 806 may also be coupled to a sensor(s) module 812, a power supply 814, an additional module of memory 816, a camera 818, and/or other related components. For example, the sensor(s) module 812 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 802 may further include a wireless baseband processor 826, which may be referred to as a modem. The wireless baseband processor 826 may have on-chip memory 826′. Along with, and similar to, the application processor 806, the wireless baseband processor 826 may also be coupled to the sensor(s) module 812, the power supply 814, the additional module of memory 816, the camera 818, and/or other related components. The wireless baseband processor 826 may be additionally coupled to one or more subscriber identity module (SIM) card(s) 820 and/or one or more transceivers 830 (e.g., wireless RF transceivers).

Within the one or more transceivers 830, the UE apparatus 802 may include a Bluetooth module 832, a wireless local area network (WLAN) module 834, a satellite positioning system (SPS) module 836 (e.g., global navigation satellite system (GNSS) module), and/or a cellular module 838. The Bluetooth module 832, the WLAN module 834, the SPS module 836, and the cellular module 838 may each include an on-chip transceiver (TRX), or in some cases, just a transmitter (TX) or just a receiver (RX). The Bluetooth module 832, the WLAN module 834, the SPS module 836, and the cellular module 838 may each include dedicated antennas and/or utilize antennas 840 for communication with one or more other nodes. For example, the UE apparatus 802 can communicate through the transceiver(s) 830 via the antennas 840 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 826 and the application processor 806 may each include a computer-readable medium/memory 826′, 806′, respectively. The additional module of memory 816 may also be considered a computer-readable medium/memory. Each computer-readable medium/memory 826′, 806′, 816 may be non-transitory. The wireless baseband processor 826 and the application processor 806 may each be responsible for general processing, including execution of software stored on the computer-readable medium/memory 826′, 806′, 816. The software, when executed by the wireless baseband processor 826/application processor 806, causes the wireless baseband processor 826/application processor 806 to perform the various functions described herein. The computer-readable medium/memory may also be used for storing data that is manipulated by the wireless baseband processor 826/application processor 806 when executing the software. The wireless baseband processor 826/application processor 806 may be a component of the UE 102. The UE apparatus 802 may be a processor chip (e.g., modem and/or application) and include just the wireless baseband processor 826 and/or the application processor 806. In other examples, the UE apparatus 802 may be the entire UE 102 and include the additional modules of the apparatus 802.

As discussed in FIG. 1 and implemented with respect to FIG. 6, the urgent data prioritization component 140 is configured to receive, from a network entity, an uplink grant to transmit a MAC PDU, the MAC PDU including a first allocation of logical channel priority with PBR data and a second allocation of remaining resources for residual data; and transmit, to the network entity, the MAC PDU with the second allocation of the remaining resources prioritizing urgent data in a logical channel buffer over the logical channel priority. The urgent data prioritization component 140 may be within the application processor 806 (e.g., at 140a), the wireless baseband processor 826 (e.g., at 140b), or both the application processor 806 and the wireless baseband processor 826. The urgent data prioritization component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 9 is a diagram 900 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 946, which may have on-chip memory 946′. In some aspects, the CU 110 may further include an additional module of memory 956 and/or a communications interface 948, both of which may be coupled to the CU processor 946. The CU 110 can communicate with the DU 108 through a midhaul link 162, such as an F1 interface between the communications interface 948 of the CU 110 and a communications interface 928 of the DU 108.

The DU 108 may include a DU processor 926, which may have on-chip memory 926′. In some aspects, the DU 108 may further include an additional module of memory 936 and/or the communications interface 928, both of which may be coupled to the DU processor 926. The DU 108 can communicate with the RU 106 through a fronthaul link 160 between the communications interface 928 of the DU 108 and a communications interface 908 of the RU 106.

The RU 106 may include an RU processor 906, which may have on-chip memory 906′. In some aspects, the RU 106 may further include an additional module of memory 916, the communications interface 908, and one or more transceivers 930, all of which may be coupled to the RU processor 906. The RU 106 may further include antennas 940, which may be coupled to the one or more transceivers 930, such that the RU 106 can communicate through the one or more transceivers 930 via the antennas 940 with the UE 102.

The on-chip memory 906′, 926′, 946′ and the additional modules of memory 916, 936, 956 may each be considered a computer-readable medium/memory. Each computer-readable medium/memory may be non-transitory. Each of the processors 906, 926, 946 is responsible for general processing, including execution of software stored on the computer-readable medium/memory. The software, when executed by the corresponding processor(s) 906, 926, 946 causes the processor(s) 906, 926, 946 to perform the various functions described herein. The computer-readable medium/memory may also be used for storing data that is manipulated by the processor(s) 906, 926, 946 when executing the software. In examples, the resource allocation component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 7, the resource allocation component 150 is configured to transmit, to a UE, a first uplink grant for a MAC PDU including a first allocation of logical channel priority with PBR data and a second allocation of remaining resources for residual data; and receive, from the UE, the MAC PDU with the second allocation of the remaining resources prioritizing urgent data in a logical channel buffer over the logical channel priority. The resource allocation component 150 may be within one or more processors of the one or more network entities 104, such as the RU processor 906 (e.g., at 150a), the DU processor 926 (e.g., at 150b), and/or the CU processor 946 (e.g., at 150c). The resource allocation component 150a-150c may be one or more hardware components specifically configured to carry out the stated processes/algorithm, implemented by one or more processors 906, 926, 946 configured to perform the stated processes/algorithm, stored within a computer-readable medium for implementation by the one or more processors 906, 926, 946, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, an uplink grant to transmit a MAC PDU, the MAC PDU including a first allocation of logical channel priority with PBR data and a second allocation of remaining resources for residual data; and transmitting, to the network entity, the MAC PDU with the second allocation of the remaining resources prioritizing urgent data in a logical channel buffer over the logical channel priority.

Example 2 may be combined with Example 1 and includes that the second allocation further prioritizes the urgent data in a first logical channel buffer having a first logical channel priority over non-urgent data in a second logical channel buffer having a second logical channel priority higher than the first logical channel priority.

Example 3 may be combined with any of Examples 1-2 and further includes receiving an indication that the urgent data includes at least one of: a remaining validity time fulfilling a first threshold criterion, or a queueing delay fulfilling a second threshold criterion.

Example 4 may be combined with Example 3 and includes that the indication includes threshold information indicating at least one of: the first threshold criterion or the second threshold criterion for the urgent data.

Example 5 may be combined with any of Examples 1-4 and includes that a plurality of logical channel buffers includes the urgent data, the urgent data being allocated to the MAC PDU from the plurality of logical channel buffers based on a decreasing order of the logical channel priority associated with the plurality of logical channel buffers.

Example 6 may be combined with Example 5 and includes that a set of logical channels have a same logical channel priority and each have urgent data in the plurality of logical channel buffers.

Example 7 may be combined with Example 6 and includes that the set of the logical channels is prioritized based on a shortest remaining validity time for next urgent data to be allocated from the plurality of logical channel buffers for the set of logical channels.

Example 8 may be combined with any of Examples 5-7 and includes that the second allocation includes: allocating the urgent data to the MAC PDU based on prioritizing a first logical channel buffer over a second logical channel buffer when the first logical channel buffer has more of the urgent data than the second logical channel buffer.

Example 9 may be combined with any of Examples 5-8 and includes that the second allocation includes: allocating the urgent data to the MAC PDU based on prioritizing the first logical channel buffer over the second logical channel buffer when the first logical channel buffer has more data dropped over a same time than the second logical channel buffer.

Example 10 may be combined with any of Examples 5-6 and includes that the second allocation includes: allocating, in a cyclical order of logical channels associated with the plurality of logical channel buffers, up to a fixed amount of the urgent data from each of the plurality of logical channel buffers that include the urgent data.

Example 11 may be combined with any of Examples 1-4 and includes that a plurality of logical channel buffers includes the urgent data, the second allocation being of the urgent data from the plurality of logical channel buffers based on a decreasing data loss rate.

Example 12 may be combined with Example 11 and includes that a data loss rate is an amount of data dropped from the logical channel buffer over time.

Example 13 may be combined with any of Examples 1-12 and includes that the second allocation of the remaining resources for the residual data is independent of a token bucket size for the logical channels when the residual data is the urgent data.

Example 14 may be combined with any of Examples 1-4 and further includes skipping the second allocation of the remaining resources from the logical channel buffer when the logical channel buffer does not include the urgent data.

Example 15 may be combined with any of Examples 1-14 and further includes transmitting, to the network entity, UE capability information indicating a capability of the UE to allocate the remaining resources that prioritize the urgent data in the logical channel buffer over the logical channel priority.

Example 16 is a method of wireless communication a network entity, including: transmitting, to a UE, a first uplink grant for a MAC PDU including a first allocation of logical channel priority with PBR data and a second allocation of remaining resources for residual data; and receiving, from the UE, the MAC PDU with the second allocation of the remaining resources prioritizing urgent data in a logical channel buffer over the logical channel priority.

Example 17 may be combined with Example 16 and includes that the second allocation further prioritizes the urgent data in a first logical channel buffer having a first logical channel priority over non-urgent data in a second logical channel buffer having a second logical channel priority higher than the first logical channel priority.

Example 18 may be combined with any of Examples 16-17 and further includes transmitting, to the UE, a configuration indicating that the urgent data includes at least one of: a remaining validity time fulfilling a first threshold criterion, or a queueing delay fulfilling a second threshold criterion.

Example 19 may be combined with Example 18 and includes that the indication includes threshold information indicating at least one of: the first threshold criterion or the second threshold criterion for the urgent data.

Example 20 may be combined with any of Examples 16-19 and includes that the MAC PDU includes an indication of an amount of urgent data in the logical channel buffer, further including: transmitting, to the UE, a second uplink grant that allocates uplink resources for at least the amount of urgent data in the logical channel buffer.

Example 21 may be combined with any of Examples 16-20 and includes that a plurality of logical channel buffers includes the urgent data, the MAC PDU having an allocation of the urgent data from the plurality of logical channel buffers based on a decreasing order of the logical channel priority associated with the plurality of logical channel buffers.

Example 22 may be combined with Example 21 and includes that a set of logical channels have a same logical channel priority and each have urgent data in the plurality of logical channel buffers.

Example 23 may be combined with Example 22 and includes that the set of the logical channels is prioritized based on a shortest remaining validity time for next urgent data in the plurality of logical channel buffers for the set of logical channels.

Example 24 may be combined with any of Examples 21-23 and includes that a first logical channel has a higher priority than a second logical channel based on the first logical channel having more of the urgent data in the logical channel buffer than the second logical channel.

Example 25 may be combined with any of Examples 21-24 and includes that the first logical channel has the higher priority than the second logical channel based on the first logical channel having more data dropped from the logical channel buffer over a same time than the second logical channel.

Example 26 may be combined with any of Examples 21-22 and includes that the second allocation is based on a cyclical order of allocation from the logical channels associated with the plurality of logical channel buffers, up to a fixed amount of the urgent data from each of the plurality of logical channel buffers that include the urgent data.

Example 27 may be combined with any of Examples 16-20 and includes that a plurality of logical channel buffers includes the urgent data, the second allocation being of the urgent data from the plurality of logical channel buffers based on a decreasing data loss rate.

Example 28 may be combined with Example 27 and includes that a data loss rate is an amount of data dropped from the logical channel buffer over time.

Example 29 may be combined with any of Examples 16-28 and includes that the second allocation of the remaining resources for the residual data is independent of a token bucket size for the logical channels when the residual data is the urgent data.

Example 30 may be combined with any of Examples 16-29 and further includes receiving, from the UE, UE capability information indicating a capability of the UE to allocate the remaining resources that prioritize the urgent data in the logical channel buffer over the logical channel priority.

Example 31 is an apparatus for wireless communication for implementing a method as in any of Examples 1-30.

Example 32 is an apparatus for wireless communication including means for implementing a method as in any of Examples 1-30.

Example 33 is a non-transitory computer-readable medium storing computer executable code, the code when executed by a processor causes the processor to implement a method as in any of Examples 1-30.

1. A method of wireless communication at a user equipment, (UE) comprising:
receiving from a network entity an uplink grant to transmit a medium access control (MAC) protocol data unit (PDU), the MAC PDU including a second allocation of resources associated with urgent data prioritization and a third allocation of remaining resources for residual data; and
transmitting, to the network entity, the MAC PDU with the second allocation of resources prioritizing urgent data in a logical channel buffer over a logical channel priority.

2. The method of claim 1, wherein the second allocation further prioritizes the urgent data in a first logical channel buffer having a first logical channel priority over non-urgent data in a second logical channel buffer having a second logical channel priority higher than the first logical channel priority.

3. The method of claim 1, further comprising:
receiving an indication that the urgent data comprises at least one of:
a remaining validity time fulfilling a first threshold criterion, or
a queueing delay fulfilling a second threshold criterion.

4. (canceled)

5. The method of claim 1, wherein a plurality of logical channel buffers includes the urgent data, the urgent data being allocated to the MAC PDU from the plurality of logical channel buffers based on a decreasing order of the logical channel priority associated with the plurality of logical channel buffers.

6. The method of claim 5, wherein a set of logical channels have a same logical channel priority and each have the urgent data in the plurality of logical channel buffers.

7. The method of claim 6, wherein the set of logical channels is prioritized based on a shortest remaining validity time for next urgent data to be allocated from the plurality of logical channel buffers for the set of logical channels.

8. The method of claim 5, wherein the second allocation comprises:
allocating the urgent data to the MAC PDU based on prioritizing a first logical channel buffer over a second logical channel buffer when the first logical channel buffer has more of the urgent data than the second logical channel buffer.

9. The method of claim 5, wherein the second allocation comprises:
allocating the urgent data to the MAC PDU based on prioritizing a first logical channel buffer over a second logical channel buffer when the first logical channel buffer has more data dropped over a same time than the second logical channel buffer.

10. The method of claim 5, wherein the second allocation comprises:
allocating, in a cyclical order of logical channels associated with the plurality of logical channel buffers, up to a fixed amount of the urgent data from each of the plurality of logical channel buffers that include the urgent data.

11. The method of claim 1, wherein a first plurality of logical channel buffers includes the urgent data and a second plurality of logical channel buffers includes non-urgent data, the urgent data from the first plurality of logical channel buffers being allocated to the MAC PDU first.

12. The method of claim 11, wherein the non-urgent data from the second plurality of logical channel buffers is allocated to the MAC PDU last.

13. The method of claim 1, wherein the third allocation of the remaining resources for the residual data is independent of a token bucket size for logical channels when the residual data is the urgent data.

14. The method of claim 1, further comprising:
skipping the third allocation of the remaining resources from the logical channel buffer when the logical channel buffer does not include the urgent data.

15. The method of claim 1, further comprising:
transmitting, to the network entity, UE capability information indicating a capability of the UE to allocate resources that prioritize the urgent data in the logical channel buffer over the logical channel priority.

16. A method of wireless communication at a network entity, comprising:
transmitting, to a user equipment, a first uplink grant for a medium access control (MAC) protocol data unit (PDU) including a second allocation of resources associated with urgent data prioritization and a third allocation of remaining resources for residual data; and
receiving, from the UE, the MAC PDU with the second allocation of resources prioritizing urgent data in a logical channel buffer over a logical channel priority.

17. The method of claim 16, further comprising:
transmitting, to the UE, a configuration indicating that the urgent data comprises at least one of:
a remaining validity time fulfilling a first threshold criterion, or
a queueing delay fulfilling a second threshold criterion.

18. The method of claim 16, wherein the MAC PDU includes an indication of an amount of urgent data in the logical channel buffer, further comprising:
transmitting, to the UE, a second uplink grant that allocates uplink resources for at least the amount of urgent data in the logical channel buffer.

19. An apparatus for wireless communication at a user equipment (UE), comprising:
a memory;
a transceiver; and
a processor coupled to the memory and the transceiver, the processor being configured to:
receive, from a network entity, an uplink grant to transmit a medium access control (MAC) protocol data unit (PDU), the MAC PDU including a second allocation of resources associated with urgent data prioritization and a third allocation of remaining resources for residual data, and
transmit, to the network entity, the MAC PDU with the second allocation of resources prioritizing urgent data in a logical channel buffer over a logical channel priority.

20. The apparatus of claim 19, wherein a first plurality of logical channel buffers includes the urgent data and a second plurality of logical channel buffers includes non-urgent data, the urgent data from the first plurality of logical channel buffers being allocated to the MAC PDU first.

21. The apparatus of claim 20, wherein the non-urgent data from the second plurality of logical channel buffers is allocated to the MAC PDU last.
